(19) United States
(12) Patent Application Publication
(10) Pub. No.: US 2017/0244941 A1
(43) Pub. Date: Aug. 24, 2017

(54) PROJECTOR AND CONTROL METHOD THEREOF

(71) Applicant: CANON KABUSHIKI KAISHA, Tokyo (JP)

(72) Inventor: Asuka Yagi, Yokohama-shi (JP)

(21) Appl. No.: 15/429,069

(22) Filed: Feb. 9, 2017

(30) Foreign Application Priority Data
Feb. 18, 2016 (JP) 2016-028797

(51) Int. Cl. H04N 9/31

(52) U.S. Cl. CPC H04N 9/3147; H04N 9/3182; H04N 9/3185

(57) ABSTRACT

A projector includes a projection optical system that projects an image based on a projection image, a plurality of liquid crystal display panels including a liquid crystal display panel that outputs a first adjustment image in a first color to the projection optical system and a liquid crystal display panel that outputs a second adjustment image in a second color, which is different from the first color, to the projection optical system, and a CPU that adjusts a position where the liquid crystal display panel outputs the second adjustment image based on an instruction to adjust the position where the liquid crystal display panel outputs the second adjustment image, which is received while a projector used for a stack projection is outputting the first adjustment image in the first color and the liquid crystal display panel is outputting the second adjustment image in the second color.

### BACKGROUND

Field of the Disclosure

The present disclosure generally relates to projection and, more particularly, to a projection device, a projection method, and a projection system.

Description of the Related Art

Conventionally, there is known a method of stack projection for projecting an image combining images respectively output from a plurality of projection devices on a screen. In stack projection, by combining the images output from the plurality of projection devices, a brighter image can be projected, compared to a case of projecting an image with a single projection device. Japanese Patent Laid-Open No. 2004-72623 discloses a technology that a plurality of projection devices respectively generate and project adjustment images in different colors and placement positions of the plurality of projection devices are adjusted based on a number of regions having a combined color generated by overlapping the plurality of adjustment images.

In a conventional method, since the combined color is projected when the positions of the images projected by the plurality of projection devices are overlapped, the user can adjust the placement positions and placement directions of the projection devices so that the only combined color is projected and the images projected by the plurality of projection devices overlap. However, even with the conventional method, the misalignment of the plurality of colors that compose the images projected by the projection devices cannot be adjusted.

For example, regarding a liquid crystal projector that projects images from liquid crystal display panels corresponding to each color of red/green/blue (hereinafter, referred to as “R/G/B”), there may occur a physical misalignment of the liquid crystal display panels or misregistration that images of each color of R/G/B are shifted due to magnification chromatic aberration which is an optical characteristic. In a condition that the images including each color of R/G/B are being projected, it is difficult to correct misregistration of each color.

### SUMMARY

Therefore, one or more aspects of the present disclosure have been made in view of the above discussion and to provide a projection device, a projection method, and a projection system that can easily correct misregistration.

According to an aspect of the present disclosure, a projector includes a first image output unit configured to output a first adjustment image in a first color to a projection unit, a second image output unit configured to output a second adjustment image in a second color, which is different from the first color, to the projection unit, and a control unit configured to display the first adjustment image in the first color and the second adjustment image in the second color and adjust a display position of each color, wherein, when another projection device having a projection area, which includes at least one overlapped part, outputs the first adjustment image in the first color, the control unit is configured to output the second adjustment image in the second color and accepts an instruction to adjust a position of the second adjustment image from the second image output unit.

Further, according to another aspect of the present disclosure, a projector includes a first image output unit configured to output a first adjustment image in a first color to a projection unit, a second image output unit configured to output a second adjustment image in a second color, which is different from the first color, to the projection unit, a control unit configured to display the first adjustment image in the first color and the second adjustment image in the second color and adjust a display position of each color, and a transmission unit configured to transmit an instruction to another projection device having a projection area, which includes at least one overlapped part, to output the second adjustment image in the second color, which is different from the first color, in a condition that the first adjustment image is being projected.

Further features of the present application will become apparent from the following description of exemplary embodiments (with reference to the attached drawings).

### BRIEF DESCRIPTION OF THE DRAWINGS

FIG. 1 is a perspective view of a projection system S according to one or more aspects of the present disclosure.

FIGS. 2A to 2C are diagrams for explaining misregistration according to one or more aspects of the present disclosure.

FIGS. 3A and 3B are diagrams for explaining a method for correcting misregistration according to one or more aspects of the present disclosure.

FIGS. 4A to 4C are diagrams for explaining a process for correcting misregistration by using an adjustment image according to one or more aspects of the present disclosure.

FIG. 5 is a flowchart for explaining a procedure of correcting misregistration according to one or more aspects of the present disclosure.

FIG. 6 is a diagram illustrating a configuration of a projector 20 according to one or more aspects of the present disclosure.

FIGS. 7A to 7C are diagrams for explaining an operation to shift a projection position of an image according to one or more aspects of the present disclosure.

FIG. 8 is a flowchart of a basic operation of the projector 20 according to one or more aspects of the present disclosure.

FIG. 9 is a block diagram of an internal configuration of an image processing unit 140 according to one or more aspects of the present disclosure.

FIGS. 10A and 10B are diagrams for explaining an operation of a shape adjustment processing unit 330 according to one or more aspects of the present disclosure.

FIG. 11 is a flowchart illustrating a procedure executed by a CPU 110 according to one or more aspects of the present disclosure.

FIG. 12 is a flowchart of an operation for correcting misregistration according to one or more aspects of the present disclosure.

FIG. 13 is a flowchart of a modification example of a misregistration correction process according to one or more aspects of the present disclosure.

FIG. 14 is a flowchart of an operation for correcting misregistration based on an image captured by an image capturing unit 192 according to one or more aspects of the present disclosure.

### DESCRIPTION OF THE EMBODIMENTS

### [Outline of Projection System S]

### (System Configuration)

Exemplary embodiments for implementing aspects of the present disclosure will be described below with reference to the drawings.

The following will describe a case of a stack projection in which almost all projection areas of a plurality of projectors are overlapped. However, the content of the present application may also be applied to a so-called multi projection that forms a wider projection area by overlapping only a part of the projection areas of the plurality of projectors. That is, the content of the present application is preferable in a projection method in which at least a part of projection areas is overlapped.

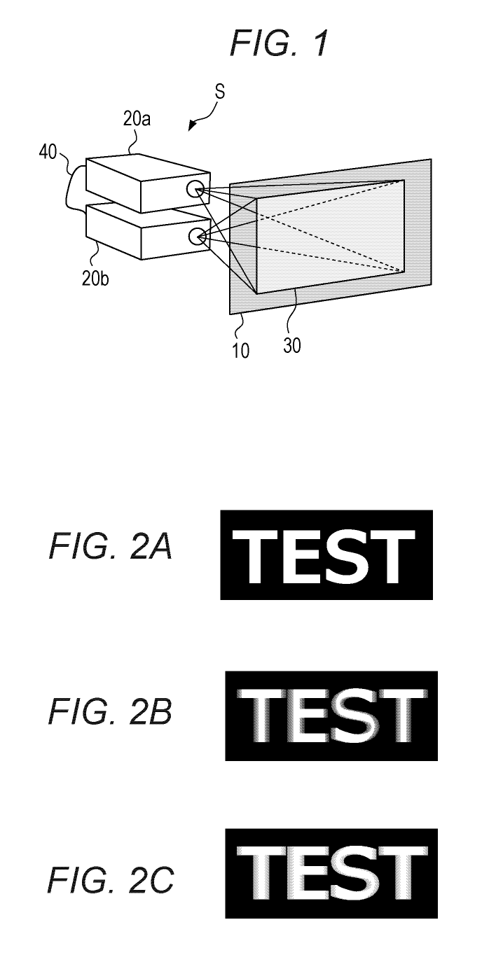

FIG. 1 is a perspective view of a projection system S according to one or more aspects of the present disclosure. The projection system S includes a projector 20a and a projector 20b. The projector 20a and projector 20b receive an input of an image from an external device and project a projection image based on the input image to a screen 10. The projector 20a and projector 20b perform a stack projection for projecting a same projection image to a same position (a projection surface 30 of FIG. 1) on the screen 10. The projector 20a and projector 20b are connected to each other via a communication cable 40 and transmit and receive data to and from each other. The projector 20a and projector 20b are projection devices having the same configuration and are referred to as a projector 20 in the following explanation when the common configuration and process are explained.

The projector 20 is, for example, a three-plate type liquid crystal projector and projects a projection image via the liquid crystal display panels corresponding to the respective colors of R/G/B. In the liquid crystal projector, there may be caused misregistration that images of each color, which are projected via liquid crystal display panels corresponding to the respective colors are shifted. The projection system S according to the present embodiment can output adjustment images used to correct misregistration of the respective liquid crystal display panels and adjust the positions of the respective adjustment images. With such a configuration, the misregistration can be easily corrected with each single device of the projectors 20 that compose the projection system S.

Further, in a case of correcting the misregistration between the plurality of projectors 20, it is difficult for the user to determine whether or not the positions of the plurality of adjustment images match if the respective projectors 20 project a same adjustment image, and the misregistration cannot be corrected easily. In view of this problem, in the projection system S according to one or more aspects of the present disclosure, the plurality of projectors 20 project adjustment images in different colors via liquid crystal display panels corresponding to the respective different colors. With this structure, the misregistration between the plurality of projectors 20 used in the stack projection can be easily corrected.

### (Outline of Misregistration)

FIGS. 2A to 2C are diagrams for explaining misregistration. FIG. 2A illustrates a condition without misregistration and FIG. 2B illustrates a condition with misregistration. FIG. 2C illustrates a condition after misregistration is corrected.

In FIG. 2B, with respect to green (G), red (R) is misaligned to the right, blue (B) is misaligned to the left and the misaligned parts are illustrated with hatching. In FIG. 2B, due to the misregistration, the image has lower resolution and gives an impression of a defocused image.

FIG. 2C illustrates a condition that the misregistration in FIG. 2B has been corrected by image processing of shifting and adjusting a shape of an image importing position on the liquid crystal display panel. Ideally, it is desired to create the condition of FIG. 2A; however, even in the condition of FIG. 2C, the amount of misalignment of the images in each color is corrected compared to FIG. 2B and the image gives a sharper impression than that of FIG. 2B. It is noted that the image of FIG. 2C is degraded compared to the image of FIG. 2A due to image processing of distributing brightness between adjacent pixels and correcting the values of each pixel.

### (Outline of Misregistration Correction Method)

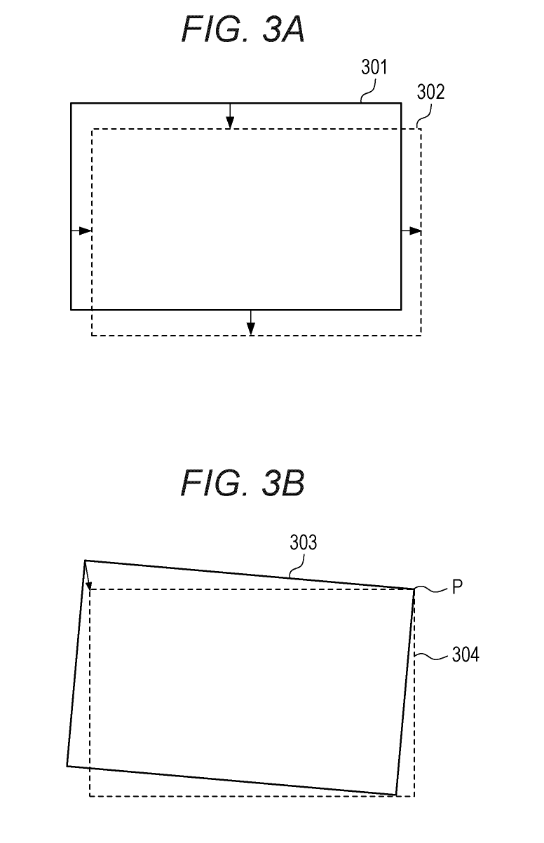

FIGS. 3A and 3B are diagrams for explaining an outline of a method for correcting misregistration. FIG. 3A illustrates a first adjusting method for shifting an entire screen in horizontal and vertical directions. In FIG. 3A, by shifting an image 301 as an adjusted target entirely in the horizontal and vertical directions, with respect to an image 302 as an adjustment goal, the image 301 and image 302 are made to be projected in a same position.

FIG. 3B illustrates a second adjusting method for rotating the entire or a part of a screen. Since an image 303 as an adjusted target in FIG. 3B has a rotational component with respect to an image 304 as an adjustment goal, the images cannot be matched in the first adjusting method. In such a case, as illustrated in FIG. 3B, by rotating the image 303 about an adjustment point P, the image 303 and the image 304 are made to be projected in a same position.

In stack projection, it is needed to adjust the positions of the respective liquid crystal display panels, which correspond to a same color, of the plurality of projectors 20. In both of the adjustment methods of FIGS. 3A and 3B, it is difficult to recognize that the adjustment is finished if the color of the adjusted target image and the color of the adjustment goal image are the same.

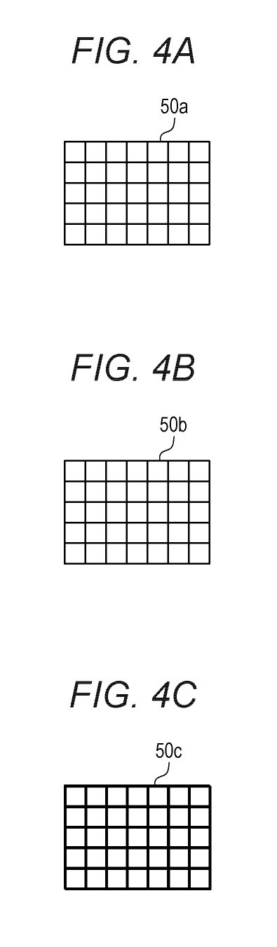

FIGS. 4A to 4C are diagrams for explaining a process to correct misregistration by using adjustment images. FIG. 4A illustrates an adjustment image 50a, which is projected via a green liquid crystal display panel of the projector 20a. FIG. 4B illustrates an adjustment image 50b, which is projected via a green liquid crystal display panel of the projector 20b. When the positions are adjusted as projecting the adjustment image 50a and adjustment image 50b which are output via the liquid crystal display panels in the same color of green from the projector 20a and the projector 20b, the positions of patters of each image get closer and an adjusted image 50c as illustrated in FIG. 4C is obtained.

In the adjusted image 50c of FIG. 4C, the adjustment image 50a and adjustment image 50b projected from the two projectors 20 are not completely overlapped but misaligned in a small degree so that the adjusted image 50c has thicker lines compared to the adjustment image 50a and the adjustment image 50b. However, it is very difficult for a user to distinguish the difference of thickness of the lines. Thus, the projector 20a and projector 20b according to one or more aspects of the present disclosure are characterized by projecting the adjustment images 50 respectively in different colors in a mode for correcting misregistration. For example, the projector 20a outputs a green adjustment image via the liquid crystal display panel for green and the projector 20b outputs a red adjustment image via a liquid crystal display panel for red.

When there is misregistration between the liquid crystal display panel, which corresponds to green, of the projector 20a and the liquid crystal display panel, which corresponds to red, of the projector 20b, the green adjustment image and red adjustment image are projected on the screen 10. On the other hand, when there is no misregistration between the liquid crystal display panel, which corresponds to green, of the projector 20a and the liquid crystal display panel, which corresponds to red, of the projector 20b, a yellow adjustment image, which is generated in combination of the green image and red image, is projected. The user can correct the misregistration between those liquid crystal display panels by adjusting the positions of the liquid crystal display panel for green of the projector 20a or the liquid crystal display panel for red of the projector 20b so as to make the adjustment image yellow.

### (Misregistration Correction Procedure)

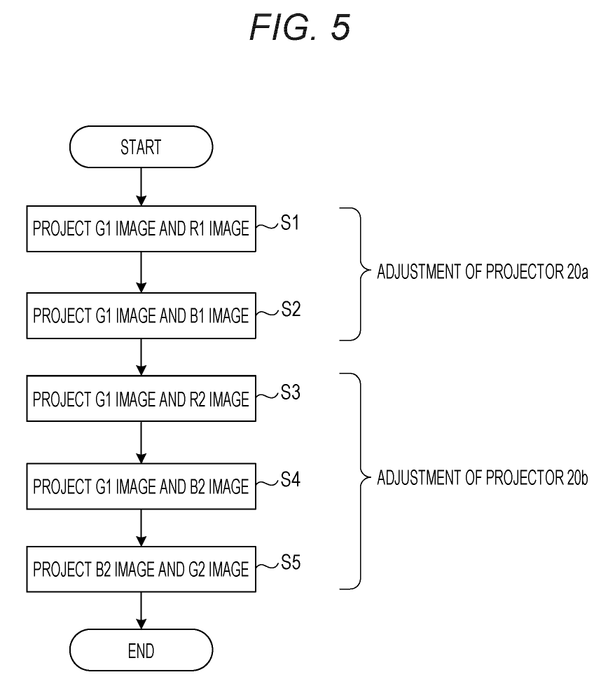

FIG. 5 is a flowchart for explaining a procedure to correct misregistration between the projector 20a and the projector 20b in the projection system S.

It is needed to correct misregistration between the liquid crystal display panels of the projector 20a serving as a reference before correcting misregistration between the liquid crystal display panels of the projector 20a and the projector 20b. For this purpose, firstly, the projector 20a projects a green adjustment image (G1 image) and a red adjustment image (R1 image) (S1). In this condition, the projector 20a adjusts a projection position of the R1 image so that the projection position of the R1 image overlaps with the projection position of the G1 image in response to user's operation for example.

Next, in response to user's operation indicating that the adjustment of the projection position of the R1 image has finished, the projector 20a stops projecting the R1 image and projects a blue adjustment image (B1 image) as well as the G1 image (S2). In this condition, according to user's operation, the projector 20a adjusts the projection position of the B1 image so that the projection position of the B1 image overlaps with the projection position of the G1 image.

In response to user's operation indicating that the adjustment of the projection position of the B1 image has finished, the projector 20a stops projecting the B1 image and transmits an instruction to project a red adjustment image (R2 image) which color is different from the G1 image, to the projector 20b. The projector 20a transmits, for example, an instruction that includes information indicating the color of the adjustment image being projected from itself or an instruction that specifies a color of an adjustment image to be projected by the projector 20b. The projector 20b projects an R2 image based on the received instruction, and accordingly this causes a condition that the G1 image is projected from the projector 20a and the R2 image is projected from the projector 20b (S3). In this condition, in response to user's operation, the projector 20b adjusts the projection position of the R2 image so that the projection position of the R2 image overlaps with the projection position of the G1 image.

In response to user's operation indicating that the adjustment of the projection position of the R2 image has finished, the projector 20b stops projecting the R2 image and projects an adjustment image (for example, a B2 image) in a color (for example, blue) different from the color of the adjustment image being projected by the projector 20a. This causes a condition that the G1 image is projected from the projector 20a and a B2 image is projected from the projector 20b (S4). In this case, in response to user's operation, the projector 20b adjusts the projection position of the B2 image so that the projection position of the B2 image overlaps with the projection position of the G1 image.

In response to user's operation indicating that the adjustment of the projection position of the B2 image has finished, the projector 20b stops projecting the B2 image, projects a green adjustment image (G2 image), and transmits, to the projector 20a, an instruction to stop projecting the G1 image. Next, to adjust the projection position of the G2 image by the projector 20b, the projector 20a or the projector 20b projects an image in a color different from the color of the G1 image and the G2 image. For example, the projector 20b projects the B2 image. This causes a condition that the projector 20a does not project any adjustment image and the projector 20b projects the B2 image and G2 image (S5). In response to user's operation, the projector 20b adjusts the projection position of the G2 image so that the projection position of the G2 image overlaps with the adjusted projection position of the B2 image.

With the above described procedure, the user can adjust the positions of the liquid crystal display panels of all colors of the projector 20a and the projector 20b.

Here, in above step S5, the image to be projected with the G2 image is not limited to the B2 image and may be any image which is not the G1 image and is already adjusted with its projection position.

### [Configuration of Projector 20]

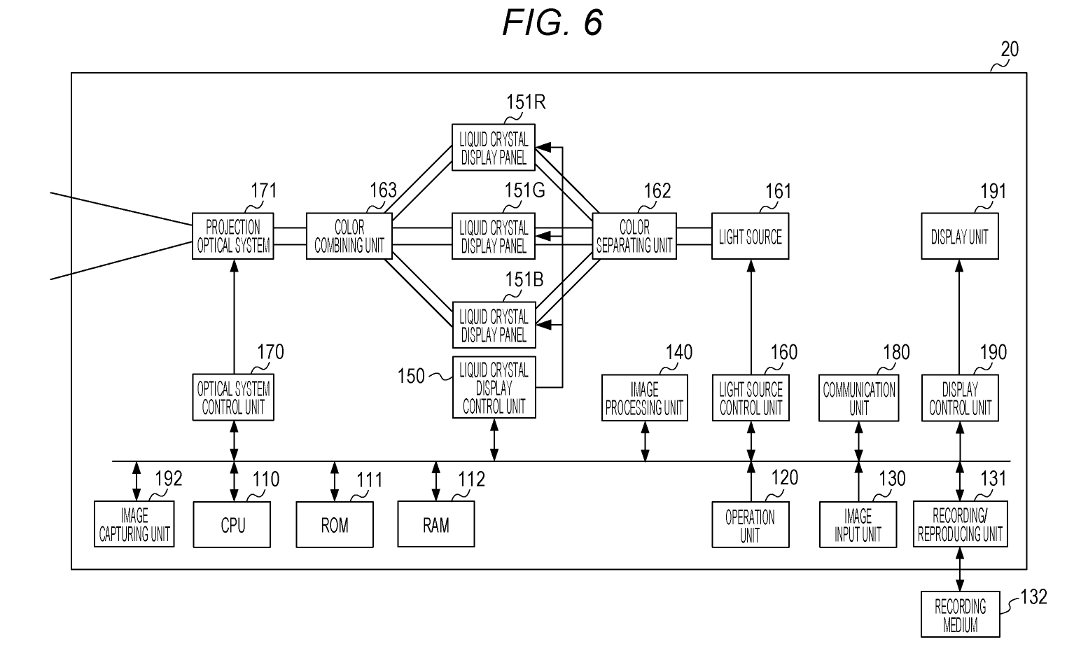

FIG. 6 is a diagram illustrating a configuration of the projector 20. Hereinafter, with reference to FIG. 6, the detailed configuration of the projector 20 will be described.

The projector 20 according to one or more aspects of the present disclosure includes a central processing unit (CPU) 110, a read only memory (ROM) 111, a random-access memory (RAM) 112, an operation unit 120, an image input unit 130, a recording/reproducing unit 131, an image processing unit 140, a liquid crystal display control unit 150, liquid crystal display panels 151R, 151G and 151B, a light source control unit 160, a light source 161, a color separating unit 162, a color combining unit 163, an optical system control unit 170, a projection optical system 171, a communication unit 180, a display control unit 190, a display unit 191 and an image capturing unit 192. As used herein, the term “unit” generally refers to hardware, firmware, software or other component, such as circuitry, alone or in combination thereof, that is used to effectuate a purpose.

The CPU 110, which may include one or more processors and one or more memories, is a control unit for controlling each operation block in the projector 20 by executing a control program stored in the ROM 111. The ROM 111 stores the control program that describes a procedure of the CPU 110. The RAM 112 temporarily stores, as a work memory, the control program and data. The CPU 110 temporarily stores still image data and moving image data received by the communication unit 180 and reproduces respective images and videos by using the program stored in the ROM 111. Further, the CPU 110 receives a control signal input from the operation unit 120 or communication unit 180 and controls each operation block in the projector 20.

The operation unit 120 is a receiving unit for receiving user's instruction and transmits, to the CPU 110, an instruction signal indicating a content of received instruction. The operation unit 120 receives, for example, an operation for setting a mode for correcting misregistration of the projector 20, an operation for adjusting an output position of the adjustment image, an operation to finish the adjustment of the output position of the adjustment image, or the like. The operation unit 120 is, for example, a switch, a dial, a touch panel provided on the display unit 191, or the like. Further, the operation unit 120 is a signal reception unit that receives a signal from a remote control for example and may transmit, to the CPU 110, a predetermined instruction signal based on the received signal.

The image input unit 130 is an image acquiring unit for acquiring a video signal from an external device. The external device may be any device that can output a video signal, such as a personal computer, a camera, a mobile phone, a smartphone, a hard disk recorder, a gaming device, or the like. The image input unit 130 includes, for example, a composite terminal, an S-video terminal, a D-terminal, a component terminal, an analog RGB terminal, a DVI-I terminal, a DVI-D terminal, an high-definition multimedia (HDMI) (registered trademark) terminal, or the like. When an analog video signal is received, the image input unit 130 converts the received analog video signal into a digital video signal. Then, the image input unit 130 transmits the converted digital video signal to the image processing unit 140.

The recording/reproducing unit 131 reproduces still image data or moving image data read from a recording medium 132, receives an image obtained by an image capturing unit 192, still image data or moving image data of a video from the CPU 110, and records the received image or data to the recording medium 132. Further, the recording/reproducing unit 131 may record still image data or moving image data received from the communication unit 180 to the recording medium 132. The recording/reproducing unit 131 includes, for example, an interface for electrically connecting with the recording medium 132 and a microprocessor for communicating with the recording medium 132. In the recording/reproducing unit 131, a dedicated microprocessor is not needed to be included and, for example, the CPU 110 may perform a process similar to that of the recording/reproducing unit 131 by executing the program stored in the ROM 111. The recording medium 132 can record still image data, moving image data, control data needed for the projector 20, or the like. The recording medium 132 may be a recording medium of any type such as a magnetic disk, an optical disc, a semiconductor memory, and the like, and may be a detachable recording medium or a built-in recording medium.

The image processing unit 140 performs a process to change a number of frames, a number of pixels, an image format and the like on a video signal received from the image input unit 130, transmits the processed signal to the liquid crystal display control unit 150, and includes a microprocessor for image processing, for example. The image processing unit 140 does not have to include a dedicated microprocessor, and, for example, the CPU 110 may function as the image processing unit 140 by executing the program stored in the ROM 111. Here, the image processing unit 140 can execute functions such as a frame thinning process, a frame interpolation process, a resolution conversion process, and a distortion correction process (keystone correction process). Further, the image processing unit 140 may perform the above described various processes on an image or a video reproduced by the CPU 110, in addition to the video signal received by the image input unit 130.

The liquid crystal display control unit 150 controls voltage to be applied to a liquid crystal of pixels of the liquid crystal display panels 151R, 151G, and 151B based on the video signal processed in the image processing unit 140, and adjusts a transmission ratio of the liquid crystal display panels 151R, 151G, and 151B. The liquid crystal display panels 151R, 151G, and 151B are a first image output unit, a second image output unit, and a third image output unit, respectively. The liquid crystal display control unit 150 includes, for example, a control microprocessor. The liquid crystal display control unit 150 does not need to include a dedicated microprocessor, and the CPU 110 may function as the liquid crystal display control unit 150 by executing the program stored in the ROM 111, for example.

When a video signal is being input to the image processing unit 140, the liquid crystal display control unit 150 controls the liquid crystal display panels 151R, 151G, and 151B so as to have a transmission ratio corresponding to the image every time one frame of image is received from the image processing unit 140. The liquid crystal display panel 151R is a liquid crystal element for red and adjusts the transmission ratio of the light of red among the light output from the light source 161 and among the light separated into red (R), green (G), and blue (B) by the color separating unit 162. The liquid crystal display panel 151G is a liquid crystal element for green and adjusts the transmission ratio of the light of green among the light output from the light source 161 and among the light separated into red, green, and blue by the color separating unit 162. The liquid crystal display panel 151B is a liquid crystal element for blue and adjusts the transmission ratio of the light of blue among the light output from the light source 161 and among the light separated into red, green, and blue by the color separating unit 162.

The liquid crystal display control unit 150 generates a driving pulse signal for driving the liquid crystal display panels 151R, 151G, and 151B from an unillustrated synchronization signal which is superimposed on the video signal. In the liquid crystal display control unit 150, the projection positions of the images can be shifted by unit of one pixel on the liquid crystal display panels 151R, 151G, and 151B by changing the importing position of the image signal by unit of one clock or one line by using a horizontal synchronization signal or a vertical synchronization signal as a reference signal.

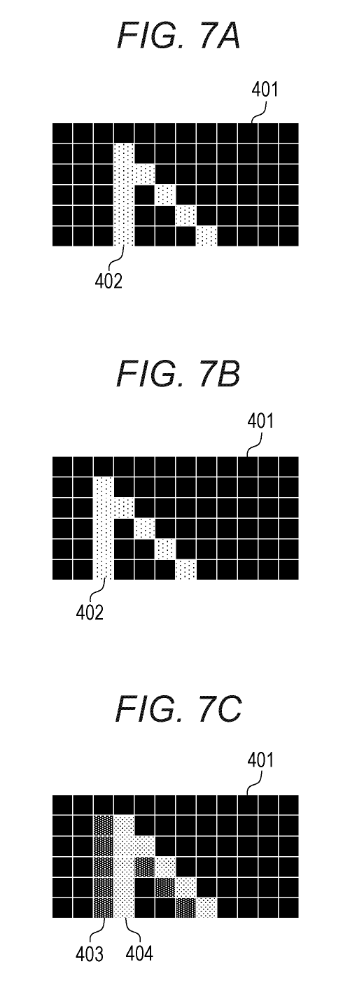

FIGS. 7A to 7C are diagrams for explaining an operation for shifting a projection position of an image. The reference numerals 401, 402, 403, and 404 in FIGS. 7A to 7C represent images in an area composed of pixels having the same gradation respectively. The image 401 in FIGS. 7A to 7C is a black (gradation value =0) image, and the image 402 is an image having a gradation value which is not zero. When the misregistration is corrected in liquid crystal display control unit 150, for example, by shifting each pixel included in the image illustrated in FIG. 7A to the left by one pixel, the projection position of the image is shifted by one pixel and this causes the condition illustrated in FIG. 7B.

Here, FIG. 7C is a diagram illustrating a condition that the projection position of the image is shifted by an amount less than one pixel. In this condition, brightness of the image 402 is distributed to the image 403 and image 404, and brightness of the image 403 and brightness of the image 404 are lower than the brightness of the image 402. The detailed method for shifting the projection position of the image by an amount less than one pixel will be described later.

Referring back to FIG. 6, the light source control unit 160 performs an on/off control of the light source 161 and controls a light amount, and has a control microprocessor. The light source control unit 160 does not need to include a dedicated microprocessor and, for example, the CPU 110 may function as the light source control unit 160 by executing the program stored in the ROM 111.

The light source 161 outputs light to project an image to the screen 10. The light source 161 is, for example, a halogen lamp, a xenon lamp, a high-pressure mercury lamp, or the like.

The color separating unit 162 separates the light output from the light source 161 into red (R), green (G), and blue (B), and is composed of, for example, a dichroic mirror, a prism, or the like. The color separating unit 162 supplies the separated light to the liquid crystal display panels 151R, 151G, and 151B. Regarding the light in each color supplied to the liquid crystal display panels 151R, 151G, and 151B, the light amount which is transmissive through each pixel of each liquid crystal display panel is restricted. Here, when an LED or the like corresponding to each color is used as the light source 161, the color separating unit 162 is not necessary.

The color combining unit 163 combines the light of red (R), green (G), and blue (B) that has passed through the liquid crystal display panels 151R, 151G, and 151B, and has a dichroic mirror, a prism, and the like, for example. The light that the color combining unit 163 has combined red (R), green (G), and blue (B) is transmitted to the projection optical system 171. In this case, the liquid crystal display panels 151R, 151G, and 151B are controlled by the liquid crystal display control unit 150 so that the transmission ratio of the light is made corresponding to the image input from the image processing unit 140. Then, when the combined light, which is combined by the color combining unit 163, is projected on the screen 10 by the projection optical system 171, an image corresponding to the image input by the image processing unit 140 is projected on the screen 10.

The optical system control unit 170 controls the projection optical system 171 to project the projection image on the screen 10 based on the image data input from the image input unit 130. The optical system control unit 170 controls the projection optical system 171 to project an adjustment image on the screen 10 in a mode for correcting misregistration. The optical system control unit 170 includes a control microprocessor. The optical system control unit 170 does not have to be a dedicated microprocessor and, for example, the CPU 110 may function as the optical system control unit 170 by executing the program stored in the ROM 111.

The projection optical system 171 is a projection unit for projecting, to the screen 10, combined light corresponding to the image processed in the image processing unit 140. The projection optical system 171 includes a plurality of lenses and an actuator for driving the lenses, and enlargement and reduction of the projected image, focus adjustment, and the like can be performed by driving the lenses by the actuator.

The communication unit 180 is a communication interface for transmitting and receiving a control signal, still image data, moving image data, and the like to and from another projector 20. The communication unit 180 transmits, to the another projector 20 for example, an instruction to output a predetermined adjustment image and adjust the position of the adjustment image. Further, the communication unit 180 serves as an acquisition unit for receiving, from the another projector 20, an instruction to output a predetermined adjustment image and adjust the position of the adjustment image. The communication unit 180 is, for example, a wireless local area network (LAN), a wired LAN, a universal serial bus (USB), Bluetooth (registered trademark), or the like and the communication method is not particularly limited. When the terminal of the image input unit 130 is, for example, an HDMI terminal, the communication unit 180 may have an interface to perform a CEC communication via the terminal.

The display control unit 190 controls to display an operation screen to operate the projector 20 and an image such as a switch icon, or the like on the display unit 191 provided to the projector 20, and includes a microprocessor for controlling the display. The display control unit 190 does not have to be a dedicated microprocessor and, for example, the CPU 110 may function as the display control unit 190 by executing the program stored in the ROM 111.

The display unit 191 displays the operation screen for operating the projector 20 and the switch icon. The display unit 191 may be any device as long as it can display an image. The display unit 191 is, for example, a liquid crystal display, a cathode ray tube (CRT) display, an organic electroluminescent (EL) display, or a light emitting diode (LED) display. The display unit 191 may turn on light emission elements such as LEDs corresponding to respective buttons so that the user can recognize a particular button.

The image capturing unit 192 captures an image of the vicinity of the projector 20 and acquires an image signal. The image capturing unit 192 can capture an image, which is projected via the projection optical system 171, by capturing an image in the direction of the screen 10. The image capturing unit 192 transmits the acquired image or video to the CPU 110, and the CPU 110 temporarily stores the image or video in the RAM 112 and converts the image into still image data or moving image data based on the program stored in the ROM 111. The image capturing unit 192 includes a lens that acquires an optical image of a subject, an actuator that drives the lens, a microprocessor that controls the actuator, an image capture element that converts the optical image acquired via the lens into an image signal, an analog to digital (AD) conversion unit that converts the image signal obtained by the image capture element into a digital signal, and the like. The image capturing unit 192 may capture an image in a direction of a viewer which is the opposite direction from the screen 10, instead of the direction of the screen 10.

### [Basic Operation of Projector 20]

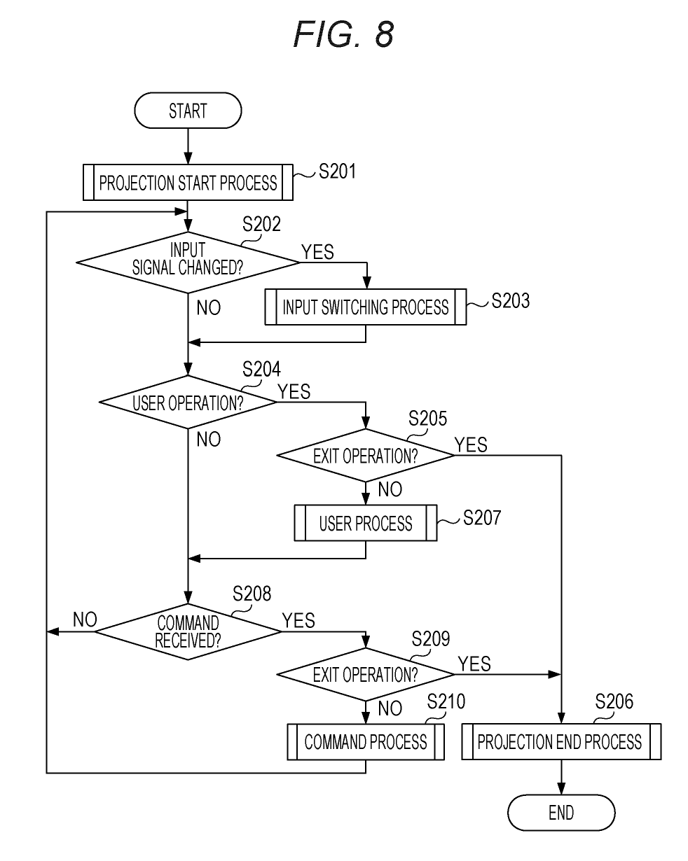

FIG. 8 is a flowchart of a basic operation of the projector 20. The operation illustrated in FIG. 8 is basically performed by the CPU 110 by controlling each function block according to the program stored in the ROM 111. The flowchart of FIG. 8 starts at timing when the user instructs to turn on the power of the projector 20 via the operation unit 120 or an unillustrated remote controller.

When the user instructs to turn on the power of the projector 20 via the operation unit 120 or remote controller, the CPU 110 supplies power from an unillustrated power source to each unit of the projector 20 and performs a projection start process (S201). In the projection start process, the CPU 110 instructs the light source control unit 160 to start a light-on control of the light source 161, instructs the liquid crystal display control unit 150 to start a drive control of the liquid crystal display panels 151R, 151G, and 151B, and sets an operating mode of the image processing unit 140.

Next, the CPU 110 determines whether or not an input signal input from the image input unit 130 has changed (S202). The CPU 110 proceeds the process to S204 when determining that the input signal has not changed, and performs an input switching process (S203) when determining that the input signal has changed. More specifically, the CPU 110 detects the resolution, frame rate, and the like of the input signals, samples an input image at preferable timing based on the detected results, and projects an image after performing necessary image processing.

Next, the CPU 110 determines whether or not there is user's operation (S204). The CPU 110 proceeds the process to S208 when determining that there is no user's operation, and determines whether or not it is an exit operation (S205) when determining there is user's operation. When determining the operation is an exit operation, the CPU 110 performs a projection end process and ends the projection process (S206). In the projection end process, the CPU 110 instructs the light source control unit 160 to perform a light-off control of the light source 161, instructs the liquid crystal display control unit 150 to perform a drive end control of the liquid crystal display panels 151R, 151G, and 151B, and stores necessary setting information to the ROM 111.

When determining that the user's operation is not an exit operation in S205, the CPU 110 performs a user process corresponding to the content of the user's operation (S207). The user process is, for example, a change of setting related to an installation condition of the projector 20, a change of an input signal type, a change of an image processing mode, a display of various pieces of information, and the like.

Next, the CPU 110 determines whether or not a command is received from the communication unit 180 (S208). When determining that there is no command received, the CPU 110 returns to the process in S202. When determining that a command has been received, the CPU 110 determines whether or not it is an exit operation (S209). When determining that it is an exit operation, the CPU 110 proceeds the process to S206. When determining that it is not an exit operation, the CPU 110 performs a command process corresponding to the content of the received command (S210). For example, the command process is setting related to the installation condition, setting of an input signal type, setting of an image process mode, an acquisition of various conditions, and the like.

It is noted that the projector 20 can project an image or a video of still image data or moving image data read by the recording/reproducing unit 131 from the recording medium 132, in addition to a video input by the image input unit 130. An image or a video of still image data or moving image data received from the communication unit 180 can also be projected.

### [Details of Image Processing Unit 140]

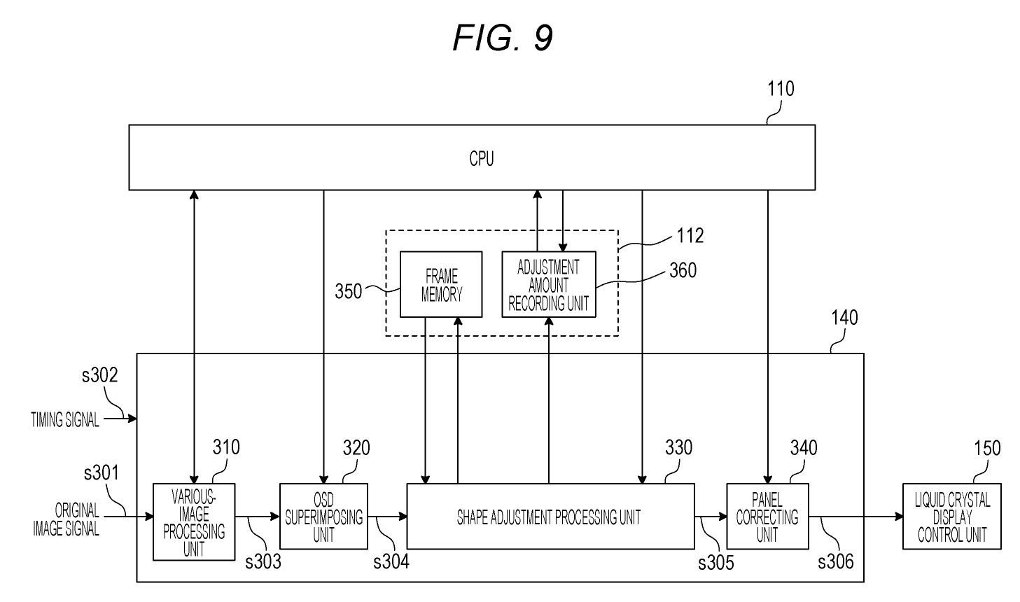

FIG. 9 is a block diagram of an internal configuration of the image processing unit 140. The image processing unit 140 includes a various-image processing unit 310, an optical scanning device (OSD) superimposing unit 320, a shape adjustment processing unit 330, and a panel correcting unit 340.

To the image processing unit 140, an original image signal s301 to be projected and a timing signal s302 are input. The original image signal s301 is an image signal input from outside and is input from the image input unit 130, recording/reproducing unit 131, or communication unit 180 according to a display mode. Further, the timing signal s302 is a timing signal such as a vertical synchronization signal, a horizontal synchronization signal, and a clock, which is synchronized with the original image signal s301, and is provided from a sender of the original image signal s301. Each block of the image processing unit 140 operates according to the timing signal s302; however, a timing signal generated in the image processing unit 140 may be used.

The various-image processing unit 310 works together with the CPU 110 and outputs, to the OSD superimposing unit 320, a processed image signal s303 after performing various image processing on the original image signal s301. The various image processing is an IP conversion, a frame rate conversion, a resolution conversion, a y conversion, a color gamut conversion, an edge emphasizing, or the like. Since these image processing are known technologies, detailed explanation thereof will not be given.

The OSD superimposing unit 320 generates an OSD-superimposed signal s304 by superimposing, as an OSD image, a user menu or operation guide information on the processed image signal s303 according to an instruction from the CPU 110. The OSD superimposing unit 320 outputs the generated OSD-superimposed signal s304 to the shape adjustment processing unit 330. The guide information includes an adjustment image used to correct misregistration.

The shape adjustment processing unit 330 performs a shape adjusting process for each color of R/G/B on the OSD-superimposed signal s304 according to an instruction from the CPU 110 and writes, to a frame memory 350, a shape-adjusted image signal s305 which is a signal after a shape adjusting process. The shape adjustment processing unit 330 generates the shape-adjusted image signal s305 by obtaining a coordinate of a pixel after the shape adjustment based on an adjustment amount determined in a misregistration correction mode, a coordinate of a pixel before the shape adjustment, and a predetermined shape adjustment formula, for example.

The shape adjustment processing unit 330 reads the shape-adjusted image signal s305 from the frame memory 350 in the RAM 112 and outputs the read shape-adjusted image signal s305 to the panel correcting unit 340 at a predetermined timing after writing the shape-adjusted image signal s305 to the frame memory 350.

In a mode for correcting misregistration, the shape adjustment processing unit 330 writes adjustment amount information indicating an amount of adjustment in the shape adjustment to an adjustment amount recording unit 360. When the operation unit 120 accepts an operation to end the adjustment of an output position of the adjustment image for example, the shape adjustment processing unit 330 writes adjustment amount information that indicates an adjustment amount determined based on an operation for adjusting the output position of the adjustment image to the adjustment amount recording unit 360. The shape adjustment processing unit 330 writes the adjustment amount information to the adjustment amount recording unit 360 as associating with the plurality of liquid crystal display panels 151 respectively.

The panel correcting unit 340 outputs, to the liquid crystal display control unit 150, a panel drive signal s306 generated by performing a correction process corresponding to characteristics of the liquid crystal display panels 151R, 151G, and 151B on the shape-adjusted image signal s305.

Next, the shape adjustment processing unit 330 will be described in detail. The shape adjustment processing unit 330 adjusts an input image into a shape corresponding to a user's instruction input via the operation unit 120. The shape adjustment processing unit 330 determines which coordinate the coordinate of a grid point determined based on user's instruction is to be shifted for example and adjusts the shape of the image by generating as interpolating a pixel value of a pixel between shifted grid points based on a pixel value of the pixel corresponding to the grid point.

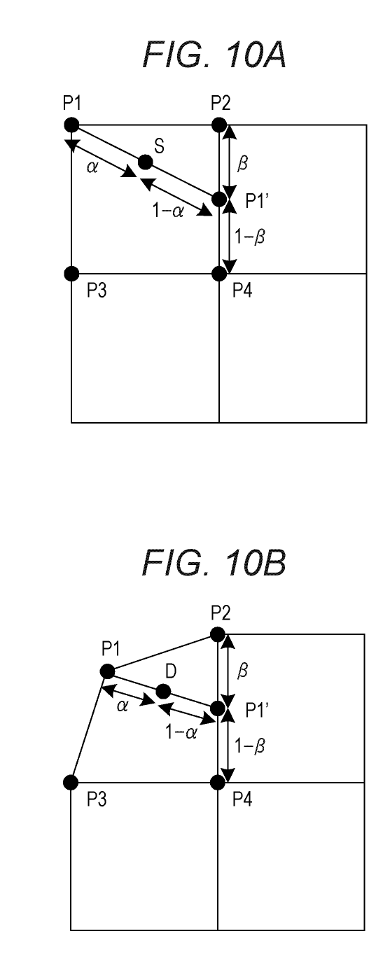

FIGS. 10A and 10B are diagrams for explaining an operation of the shape adjustment processing unit 330. Under the control by the CPU 110, to the shape adjustment processing unit 330, a coordinate after shifting the grid point placed in the image, which is determined based on the user's instruction, is input as being associated with the grid point. The shape adjustment processing unit 330 calculates a pixel value of a pixel other than the grid point by interpolating based on a grid point near a focused grid point which is to be shifted.

In the following, an interpolation method will be described with reference to FIGS. 10A and 10B. FIG. 10A illustrates a pre-shape-arrangement image before the shape adjustment processing unit 330 arranges the shape and grid points P1, P2, P3, and P4 are used in the interpolating process. FIG. 10B illustrates a shape-arranged image after the shape adjustment processing unit 330 arranged the shape. A coordinate S of the pre-shape-arrangement image of FIG. 10A becomes a coordinate D of shape-arranged image when the grid point P1 is shifted to as illustrated in FIG. 10B. P1′ is a vertex of a line passing through P1 and coordinate D and a line segment P2-P4 in FIG. 10B.

When it is assumed that the position of the coordinate S on the pre-shape-arrangement image is at position of a:1-a on the line segment P1-P1′ and the position of P1′ is at a position of β:1−β on the line segment P2-P4, the shape adjustment processing unit 330 can calculate coordinate D of the shape-arranged image based on the coordinates of the respective grid points P1, P2, P3, and P4 after arranging the shape and a ratio of α:1−α. In this case, when the coordinate D of the shape-arranged image is an integer, that is, when the coordinate D corresponds to a coordinate of one of the pixels of the input image, the shape adjustment processing unit 330 may set the pixel value of the coordinate D as the pixel value of the coordinate S on the pre-shape-arrangement image.

However, the coordinate after the shape arrangement is not always be an integer. When the coordinate after the shape arrangement is not an integer, the shape adjustment processing unit 330 determines the pixel value of the coordinate D on the shape-arranged image by interpolating with a pixel value of a pixel near the coordinate D on the shape-arranged image. The shape adjustment processing unit 330 may use a bilinear interpolation method, a bicubic interpolation method, or any other interpolation method.

The image illustrated in FIG. 7C is an image generated by the shape adjustment processing unit 330 by shifting the position of the image 402 in FIG. 7A by an amount less than one pixel with the above described method. The shape adjustment processing unit 330 distributes brightness so that an integral value of the two pixels of the image 403 and the image 404 in FIG. 7C becomes a value corresponding to the pixel value of the image 402, and determines the pixel values of the image 403 and the image 404. In an example of FIG. 7C, a brightness gravity center is adjusted to a value slightly closer to the image 404.

Since a part, in the shape-arranged image, that becomes smaller than the pre-shape-arrangement image is an effective image region, the shape adjustment processing unit 330 sets the pixel value of the relevant part to be a pixel value corresponding to black or a background color set by the user.

The shape adjustment processing unit 330 can shift the entire image by adding an offset having the same value to position information of the entire grid point, in addition to the process for adjusting a position of a part of the image in the above described manner. The shape adjustment processing unit 330 creates a shape-adjusted image by obtaining pixel values of all coordinates of the shape-arranged image with the above procedure. Further, the shape adjustment processing unit 330 performs different shape adjustments for each color of R/G/B. In this manner, the shape adjustment processing unit 330 can correct the misregistration by processing the image.

### [Operation Procedure of Misregistration Correction]

Next, in a case of correcting the misregistration in stack projection, an operation procedure to improve the visibility will be described.

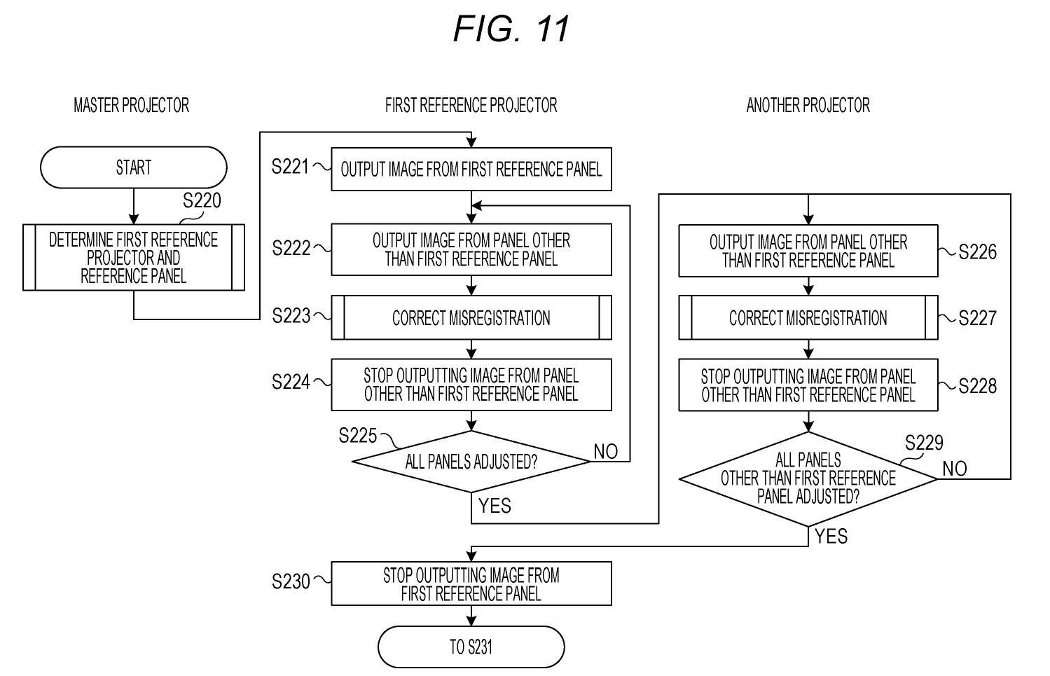

FIG. 11 is a flowchart of an operation for correcting misregistration. The operation illustrated in FIG. 11 starts when the user selects a misregistration correction mode during stack projection with the operation unit 120 or the remote controller. In the following explanation, among the plurality of projectors 20 constituting the stack projection, the projector 20 with which the user has started a process is referred to as a master projector. The master projector sends instructions to all other projectors 20.

The following explanation will be given under an assumption that the projection system S includes a projector 20 in addition to the projector 20a and the projector 20b illustrated in FIG. 1; however the present application may be applied to the case that the projection system S includes only the projector 20a and the projector 20b.

Firstly, the CPU 110 of the master projector determines a first reference projector in step S220. The master projector communicates with all other projectors 20 (which are slave projectors) via the communication unit 180 and acquires information such as resolution, brightness, or the like of each projector 20. Based on the acquired information, the master projector determines one projector 20 that has a higher resolution or one projector 20 that has a higher brightness as a first reference projector. The master projector may set itself as a first reference projector. In this case, the CPU 110 of the master projector executes misregistration correction by instructing each function unit in the master projector itself without communicating via the communication unit 180.

Further, in step S220, the CPU 110 determines a color of a first reference panel which is a liquid crystal display panel serving as a reference position of the misregistration correction. The color of the first reference panel may be any one of R/G/B; however, it is preferable that the CPU 110 selects green (G) since it is known that a person is more sensitive with green (G) because of person's visual feature.

Next, in step S221, the CPU 110 of the master projector instructs the first reference projector determined in step S220, via the communication unit 180, to project an adjustment image by using the first reference panel. Subsequently, in step S222, the CPU 110 of the master projector instructs the first reference projector to project an adjustment image by using the liquid crystal display panel 151 of a color which is not the color corresponding to the first reference panel.

In step S223, the CPU 110 of the master projector accepts user's operation and corrects the misregistration of the liquid crystal display panel 151 that projects the adjustment image in step S222, with reference to the first reference panel. Here, in a case that the first reference projector is not the master projector, the CPU 110 of the master projector notifies an adjustment instruction based on user's operation content to the first reference projector via the communication unit 180.

For example, in a case that the projector 20a is the first reference projector, the CPU 110 of the projector 20a controls the liquid crystal display panel 151G to output a green adjustment image and, as controlling the liquid crystal display panel 151B to output a blue adjustment image, adjusts the position of the blue adjustment image output by the liquid crystal display panel 151B. Further, after adjusting the position of the blue adjustment image output from the liquid crystal display panel 151B, the CPU 110 of the projector 20a controls the liquid crystal display panel 151B to stop outputting the blue adjustment image and, as controlling the liquid crystal display panel 151R to output a red adjustment image, adjusts the position of the red adjustment image output from the liquid crystal display panel 151R.

Since the first reference projector projects the adjustment images from the plurality of liquid crystal display panels 151 which correspond to different colors, the color of the image changes when the adjustment completes and the adjustment images overlap. For example, when the user adjusts the pattern of the liquid crystal display panel 151R corresponding to red (R) to be matched with the adjustment image output from the liquid crystal display panel 151G corresponding to green (G), since the overlapped part becomes yellow, the user can easily recognize that the misregistration correction is completed.

While correcting the misregistration of one of the liquid crystal display panels 151, the CPU 110 of the master projector notifies the adjustment amount to the first reference projector and controls to write the adjustment amount to the adjustment amount recording unit 360 in the RAM 112 of the first reference projector. In a case that the misregistration correction is only an adjustment in the horizontal and vertical directions as illustrated in FIG. 3A, the adjustment amount is respectively recorded for each of the liquid crystal display panel 151. When the entire image is rotated as illustrated in FIG. 3B or the user adjusts the respective selected pixels, the CPU 110 calculates an average value of the adjustment amounts of all pixels to be adjusted and records the calculated average value for each liquid crystal display panel 151. When an operation to complete the adjustment is received via the operation unit 120 or the remote controller, the CPU 110 of the master projector proceeds the process to step S224.

Next, in step S224, the CPU 110 of the master projector instructs, via the communication unit 180, to stop outputting the adjustment images of the liquid crystal display panel 151 corresponding to the color which is not the color of the first reference panel.

In step S225, the CPU 110 of the master projector determines whether the misregistration correction for all liquid crystal display panels 151 of the first reference projector has been completed, and branches the process based on the determination result. When it is determined that the adjustment for all liquid crystal display panels 151 has been completed, the CPU 110 proceeds the process to step S226. When it is determined that there is a liquid crystal display panel 151 which is not yet adjusted, the process returns to step S222, and the CPU 110 controls the liquid crystal display panel 151 which is not yet adjusted to output an adjustment image.

From step S226, the CPU 110 of the master projector controls the projector 20 which is not the first reference projector. In step S226, the CPU 110 of the master projector instructs the projector 20 which is not the first reference projector, via the communication unit 180, to output an adjustment image from the liquid crystal display panel 151 corresponding to a color (blue, for example) different from the color (green, for example) corresponding to the first reference panel. For example, in a condition that the liquid crystal display panel 151G of the projector 20a is outputting a green first adjustment image, the CPU 110 of the projector 20a transmits an instruction to the liquid crystal display panel 151B that outputs a blue second adjustment image, which is not green, of the projector 20b that is another projection device used for the stack projection to have the projection optical system 171 output a blue adjustment image.

Next, in step S227, the CPU 110 of the master projector accepts user's operation and performs a misregistration correction of the liquid crystal display panel 151 which is controlled to output the adjustment image in step S226 with reference to the first reference panel of the first reference projector. For example, in a case that the projector 20a is the master projector, the projector 20a transmits an instruction to the projector 20b to adjust the position of the second adjustment image while the projector 20b is outputting the second adjustment image. In a condition that the projector 20a outputs a green first adjustment image and the liquid crystal display panel 151B of the projector 20b outputs a blue second adjustment image, the CPU 110 of the projector 20b adjusts the position of the blue second adjustment image output from the liquid crystal display panel 151B based on the instruction received from the projector 20a.

In step S227, when the user performs an adjustment completion operation, similarly to step S223, the CPU 110 of the master projector instructs the image processing unit 140 of the projector 20 to write the adjustment amount to the adjustment amount recording unit 360 of the RAM 112 and proceeds the process to step S228. In step S227, since the color of the adjustment image projected by the first reference projector and the color of the adjustment image projected by the projector 20 are different, the color of the image changes when the adjustment has been completed and the adjustment images overlap. Thus, the user can easily recognize that the adjustment is completed.

In step S228, the CPU 110 of the master projector instructs the projector 20b serving as a second reference projector to stop projecting an adjustment image by the liquid crystal display panel 151 of a color (blue, for example) different from the color (green, for example) corresponding to the first reference panel. In step S229, the CPU 110 of the master projector determines whether the misregistration correction of all the liquid crystal display panels 151 of the projector 20 which is not the first reference projector has been completed and branches the process according to the determination result.

In a case that the adjustment for all liquid crystal display panels 151 has been completed, the CPU 110 of the master projector proceeds the process to step S230. When there is a liquid crystal display panel 151 which is not yet adjusted, the process returns to step S226 and the CPU 110 of the master projector controls the liquid crystal display panel 151 which is not yet adjusted to project an adjustment image. As a final step of the adjustment with reference to the first reference projector, in step S230, the CPU 110 of the master projector instructs the first reference projector to stop projecting the adjustment image from the first reference panel.

Here, in a case that the projection system S includes three or more projectors 20 which composes the stack projection, the CPU 110 of the master projector performs the processes from step S226 to step S229 on the rest of the projectors 20.

In a case that the color of the first reference panel is green (G), up to step S230, the misregistration correction for the red liquid crystal display panels 151R and blue liquid crystal display panels 151B of all the projectors 20 is completed. Next, a procedure for correcting the misregistration of the green liquid crystal display panel 151G of the projector 20 which is not the first reference projector will be explained.

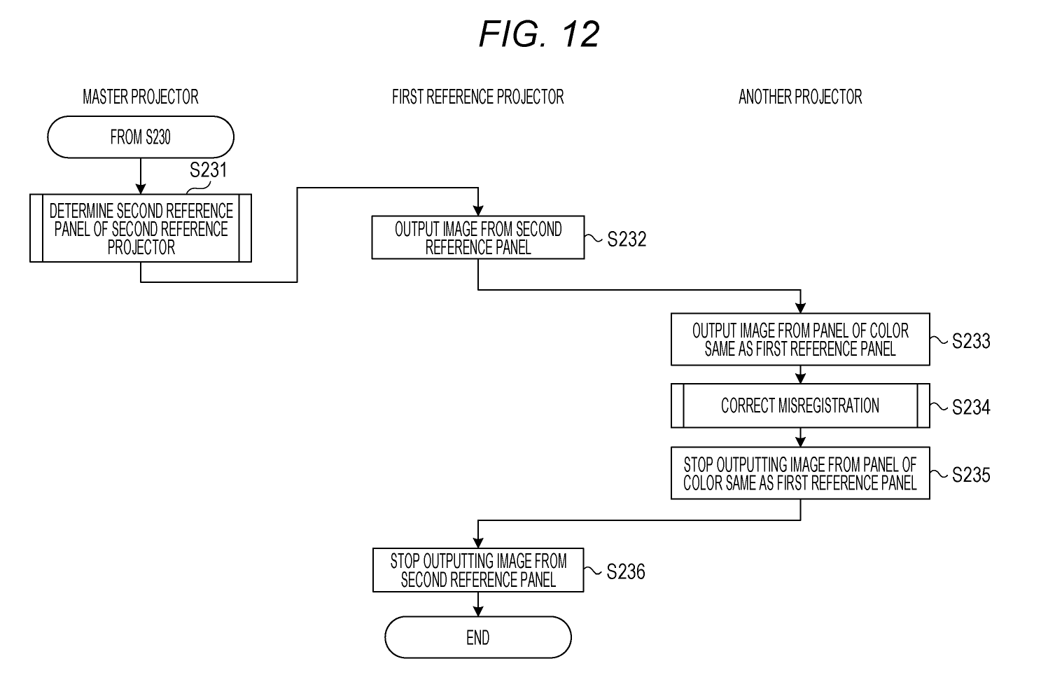

FIG. 12 is a flowchart of an operation to correct misregistration of the liquid crystal display panel 151G.

When the color of the first reference panel is green (G), the misregistration correction of red (R) and blue (B) is completed in or before step of S230. Thus, the color of the second reference panel is red (R) or blue (B), and the following process is a process to correct the misregistration of the liquid crystal display panel 151G of green (G) of the projector 20 which is not the first reference projector.

In step S231, the CPU 110 of the master projector determines a second reference panel of the second reference projector. The second reference projector is a projector 20, which is not the first reference projector, that serves as a reference when the misregistration of the unadjusted liquid crystal display panel 151 is corrected. In steps S223 and S227, the CPU 110 of the master projector selects a second reference projector and a second reference panel based on the adjustment amount written in the adjustment amount recording unit 360 of each projector 20. The CPU 110 of the master projector, for example, selects the projector 20 including the liquid crystal display panel 151 having a smallest adjustment amount as the second reference projector and selects the liquid crystal display panel 151 having the smallest adjustment amount as the second reference panel.

As described with reference to FIG. 7C, the shape adjustment processing unit 330 makes an adjustment of less than a width of one pixel by distributing brightness of a plurality of pixels to one pixel. Thus, when the adjustment amount is an integer, that is, when the adjustment amount is closer to the width of one pixel, sharpness of the image improves since blur due to the brightness distribution is corrected. When the sharpness of the adjustment image output from the liquid crystal display panel 151 used as a reference of the misregistration correction is higher, the visibility when correcting the misregistration improves and this realizes higher adjustment accuracy. Thus, the CPU 110 of the master projector may select a liquid crystal display panel 151 having an adjustment amount closest to the integer, from the adjustment amounts of the respective liquid crystal display panels 151 of each projector 20, which are written in the adjustment amount recording unit 360, as a second reference panel, and set the projector 20 having the liquid crystal display panel 151 as a second reference projector. Here, the CPU 110 of the master projector can read the adjustment amounts written in the adjustment amount recording unit 360 of each projector 20 into the RAM 112 in the master projector itself via the communication unit 180.

In step S232, the CPU 110 of the master projector instructs the second reference projector to output an adjustment image from the second reference panel.

Next, in step S233, the CPU 110 of the master projector instructs a projector 20, which is not the second reference projector, to output an adjustment image from the liquid crystal display panel 151G corresponding to green (G) which is the same as the color of the first reference panel.

In step S234, the CPU 110 of the master projector accepts user's operation and corrects the misregistration of the liquid crystal display panel 151G that outputs the adjustment image in step S233 with reference to the second reference panel. The details of the adjustment are similar to those of step S223. When the misregistration correction is finished, the CPU 110 of the master projector proceeds the process to step S235 and instructs the image processing unit 140 of the projector 20 which is not the second reference projector, via the communication unit 180, to stop outputting the adjustment image from the liquid crystal display panel 151G of green (G) corresponding to the first reference panel.

As a final process of the adjustment by referring to the second reference projector, in step S236, the CPU 110 of the master projector instructs the image processing unit 140 of the second reference projector, via the communication unit 180, to stop outputting the adjustment image from the second reference panel and ends the process. Here, in a case that the projection system S includes three or more projectors 20 composing the stack projection, the CPU 110 of the master projector performs the processes from step S233 to step S235 for the rest of the projectors 20.

After the registration adjustment is finished, the CPU 110 of each projector 20 controls the plurality of liquid crystal display panels 151 to respectively output projection images based on image data input from the image input unit 130 at output positions indicated by the adjustment amount information that is respectively associated with the plurality of liquid crystal display panels 151 and stored in the adjustment amount recording unit 360. This configuration improves the quality of the stack projection since images of each color without misregistration can be projected from each projector 20.

Here, in the above explanation, the adjustment amount of the misregistration correction is written in the adjustment amount recording unit 360 of each projector 20; however, the adjustment amount of each projector 20 may be written to the RAM 112 of the master projector.

### [First Modification]

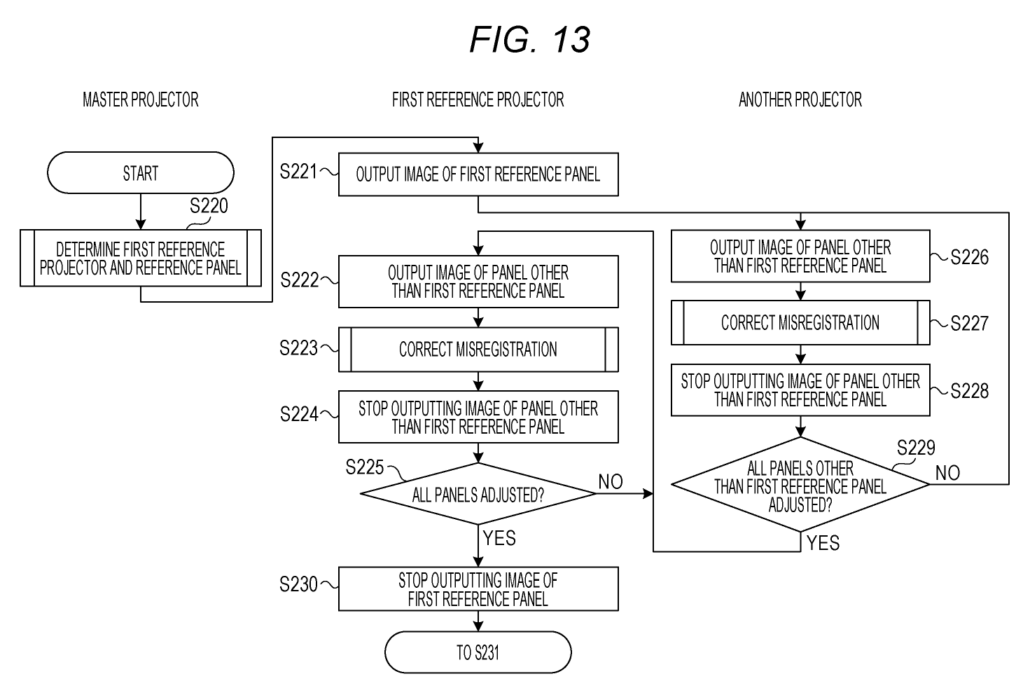

FIG. 13 is a flowchart of a modification of the misregistration correction process by using the first reference panel of the first reference projector as a reference. In the misregistration correction by using the first reference panel of the first reference projector as a reference, the misregistration correction of the liquid crystal display panels 151 of the projector 20 which is not the first reference projector may be performed before performing the misregistration correction of the liquid crystal display panels 151 of the first reference projector.

More specifically, after step S221, the CPU 110 of the master projector proceeds to the process in step S226 and controls the projector 20 which is not the first reference projector to output an adjustment image from the liquid crystal display panel 151 corresponding to a color which is not the color (green, for example) of the first reference panel of the first reference projector. The processes from step S227 to S229 are similar to those in FIG. 11.

The CPU 110 of the master projector proceeds to the process in step S222 after step S229 and controls the first reference projector to output an adjustment image from the liquid crystal display panel 151 corresponding to a color different from the color of the first reference panel. The processes from step S222 to S225 are the same as those in FIG. 11. The CPU 110 of the master projector proceeds to the process in step S230 after step S225 and controls the first reference projector to end outputting the adjustment image from the first reference panel.

### [Second Modification]

In the above explanation, the CPU 110 shifts the image based on an operation input by the user via the remote controller or the like in the misregistration correction process in steps S223, S227, and S234 of FIGS. 11 and 12; however, this example does not set any limitation. The CPU 110 may perform a misregistration correction based on the image that is the adjustment image being projected captured by the image capturing unit 192, without receiving user's operation.

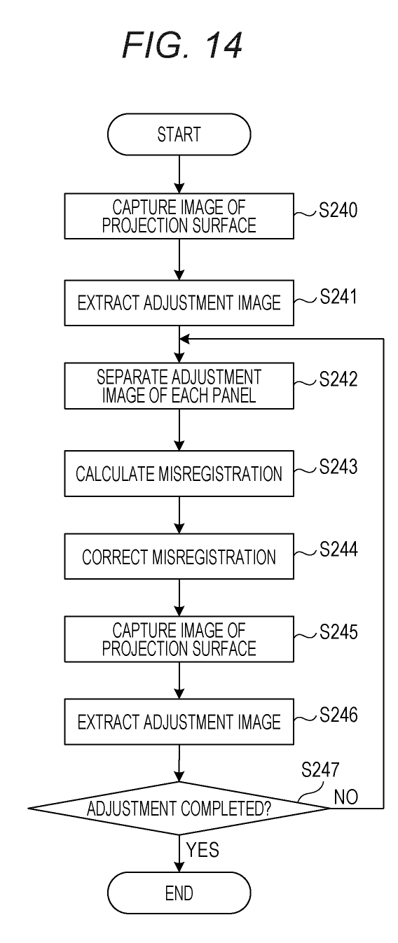

FIG. 14 is a flowchart of an operation that the CPU 110 performs a misregistration correction based on an image captured by the image capturing unit 192. The operation illustrated in FIG. 14 starts when the process proceeds to the misregistration correction process in steps S223, S227, and S234 of FIGS. 11 and 12.

In step S240, the CPU 110 controls the image capturing unit 192 to capture a projection surface. According to the control by the CPU 110, the image capturing unit 192 writes a captured image to the RAM 112. Next, in step S241, the CPU 110 reads the captured image from the RAM 112 and instructs the image processing unit 140 to extract adjustment images in different colors. The image processing unit 140 can extract an adjustment image by using a known image processing method such as binarization, thinning, pattern matching, or the like.

Next, in step S242, the image processing unit 140 determines to which liquid crystal display panel 151 the adjustment image extracted in step S241 corresponds and separates each adjustment image. The image processing unit 140 writes coordinates indicating positions of the separated adjustment images to the RAM 112.

Next, in step S243, the CPU 110 calculates a misregistration amount based on the plurality of adjustment images separated in step S242. In step S244, the CPU 110 instructs the image processing unit 140 to adjust at least one of the position of a first color adjustment image and the position of a second color adjustment image based on the positions of the first color adjustment image and the second color adjustment image captured by the image capturing unit 192 while the first color adjustment image and second color adjustment image are being projected. The CPU 110 corrects the misregistration by controlling to execute a shape adjusting process for adjusting a position of the second color adjustment image by a misregistration amount corresponding to a difference between the position of the first color adjustment image and the position of the second color adjustment image, for example, and controls to output adjusted adjustment images from the liquid crystal display panels 151.

In step S245, the CPU 110 instructs the image capturing unit 192 to capture an image of the projection surface 30 on which the adjusted adjustment images are being projected. In step S246, the CPU 110 reads a captured image written in the RAM 112 by the image capturing unit 192 and instructs the image processing unit 140 to extract a plurality of adjustment images again. In step S247, the CPU 110 determines whether or not the adjustment has been completed based on the color of the adjustment image extracted in step S246 and branches the process based on the determination result.

The CPU 110 compares the adjustment images separated in step S242 with the color of the pattern extracted in step S246, determines that the adjustment has been completed when the colors are different, and ends the process. When the compared colors are the same, the CPU 110 returns to the process in step S242 and performs the adjustment again. In this case, in the captured image, the CPU 110 may determine that the adjustment is completed when a color ratio of the adjustment images separated in step S242 is equal to or lower than a predetermined threshold value.

According to one or more aspects of the present disclosure, since a plurality of adjustment images in different colors are projected, in step S242, the image processing unit 140 can easily separate the adjustment images based on the color difference. Further, also in a case that the CPU 110 determines whether or not the adjustment is completed in step S247, the completion of the adjustment can be determined with a higher accuracy by detecting that the color has changed as the adjustment images overlap.

### [Effects of One or More Aspects of the Present Disclosure]

As described above, in the projection system S according to one or more aspects of the present disclosure, the projector 20 projects a plurality of adjustment images in different colors in a mode for correcting misregistration. With this configuration, the correction can be performed with higher accuracy even when the user performs the adjustment operation or when the CPU 110 performs the adjustment process based on the image captured by the image capturing unit 192.

Further, according to the procedure of one or more aspects of the present disclosure, in a condition that a first color adjustment image is being output from the liquid crystal display panel 151 serving as a reference of the projector 20 serving as a reference, the misregistration of the liquid crystal display panels 151 corresponding to another color of the projector 20 serving as a reference and another projector 20 is corrected. In a condition that an adjustment image of one color among other colors is being output, the misregistration of the liquid crystal display panel 151 corresponding to the first color of the another projector 20 is corrected. With this configuration, since a difference in the misregistration correction is not accumulated, the sharpness of the image after the misregistration correction can be improved.

In the above, the present application has been described according to one or more aspects of the present disclosure; however, the technical scope of the present application is not limited to the above embodiments and various modifications and changes can be made within the scope.

### Other Embodiments

Embodiment(s) of the present application can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors and one or more memories (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present application has been described with reference to exemplary embodiments, it is to be understood that the application is not limited to the disclosed exemplary embodiments. The scope of the following claims is to be accorded the broadest interpretation so as to encompass all such modifications and equivalent structures and functions.

This application claims the benefit of priority from Japanese Patent Application No. 2016-028797, filed Feb. 18, 2016, which is hereby incorporated by reference herein in its entirety.

What is claimed is:

1. A projector comprising:
a first image output unit configured to output a first adjustment image in a first color to a projection unit;
a second image output unit configured to output a second adjustment image in a second color, which is different from the first color, to the projection unit; and
a control unit configured to display the first adjustment image in the first color and the second adjustment image in the second color and adjust a display position of each color,
wherein, when another projection device having a projection area, which includes at least one overlapped part, outputs the first adjustment image in the first color, the control unit is configured to output the second adjustment image in the second color and accepts an instruction to adjust a position of the second adjustment image from the second image output unit.

2. The projector according to claim 1,
wherein the second image output unit outputs the second adjustment image in response to an instruction to output the second adjustment image from the another projection device.

3. The projector according to claim 1,
further comprising a third image output unit configured to output a third adjustment image in a third color, which is different from the first color and the second color, to the projection unit,
wherein, when a position adjustment of the second adjustment image is finished, an instruction to adjust a position of the third adjustment image from the third image output unit is accepted.

4. The projector according to claim 1,
wherein the adjustment image corresponds to a color of a liquid crystal display panel.

5. The projector according to claim 1,
wherein, when an adjustment amount of the display position is smaller than one pixel, a pixel value of a shifted display position is determined by an interpolating process with a pixel value of a peripheral pixel.

6. The projector according to claim 1,
wherein an instruction to adjust the position is received from a remote controller.

7. The projector according to claim 1,
further comprising a unit configured to output an instruction to adjust the position by analyzing an image acquired by an image capturing unit.

8. A projector comprising:
a first image output unit configured to output a first adjustment image in a first color to a projection unit;
a second image output unit configured to output a second adjustment image in a second color, which is different from the first color, to the projection unit;
a control unit configured to display the first adjustment image in the first color and the second adjustment image in the second color and adjust a display position of each color; and
a transmission unit configured to transmit an instruction to another projection device having a projection area, which includes at least one overlapped part, to output the second adjustment image in the second color, which is different from the first color, in a condition that the first adjustment image is being projected.

9. The projector according to claim 8,
wherein an instruction to adjust the position of the second adjustment image is received and the instruction is transferred to the another projection device.

10. The projector according to claim 8,
wherein the another projection device comprises a third image output unit configured to output a third adjustment image in a third color, which is different from the first color and the second color, to the projection unit, and
when the adjustment of the position of the second adjustment image is finished, an instruction to output the third adjustment image from the third image output unit is transmitted to the another projection device.

11. The projector according to claim 8,
wherein the adjustment image corresponds to a color of a liquid crystal display panel.

12. The projector according to claim 8,
wherein, when an adjustment amount of the display position is smaller than one pixel, a pixel value of a shifted display position is determined by an interpolating process with a pixel value of a peripheral pixel.

13. The projector according to claim 8,
wherein an instruction to adjust the position is received from a remote controller.

14. The projector according to claim 8,
further comprising a unit configured to output an instruction to adjust the position by analyzing an image acquired by an image capturing unit.

15. A projector control method comprising:
a first image output step of outputting a first adjustment image in a first color to a projection unit;
a second image output step of outputting a second adjustment image in a second color, which is different from the first color, to the projection unit; and
a control step of displaying the first adjustment image in the first color and the second adjustment image in the second color and adjusting a display position of each color,
wherein, in the control step, when another projection device having a projection area, which includes at least one overlapped part, is outputting the first adjustment image in the first color, an instruction to output the second adjustment image in the second color and adjust the position of the second adjustment image in the second image output step is accepted.

16. A projector control method comprising:
a first image output step of outputting a first adjustment image in a first color to a projection unit;
a second image output step of outputting a second adjustment image in a second color, which is different from the first color, to the projection unit;
a control step of displaying the first adjustment image in the first color and the second adjustment image in the second color and adjusting a display position of each color; and
a transmission step of transmitting an instruction to output the second adjustment image in the second color, which is different from the first color, to another projection device having a projection area, which includes at least one overlapped part, in a condition that the first adjustment image is being projected.
